(19) United States
(12) Patent Application Publication
(10) Pub. No.: US 2026/0198562 A1
(43) Pub. Date: Jul. 16, 2026

(54) HYBRID AEROSOL-GENERATING DEVICE WITH SINGLE INDUCTION COIL

(71) Applicant: Philip Morris Products S.A., Neuchatel (CH)

(72) Inventors: Rui Nuno Rodrigues Alves BATISTA, Morges (CH); Ricardo CALI, Mannheim (DE); Silvia CAPO, Neuchâtel (CH)

(73) Assignee: Philip Morris Products S.A., Neuchatel (CH)

(21) Appl. No.: 19/134,531

(22) PCT Filed: Dec. 11, 2023
(86) PCT No.: PCT/EP2023/085192

§ 371 Date: May 30, 2025

(30) Foreign Application Priority Data
Dec. 15, 2022 (EP) 22213781

(51) Int. Cl. A24F 40/30; A24F 40/10; A24F 40/20; A24F 40/465; A24F 40/485; A24F 40/60; H05B 6/10; H05B 6/36

(52) U.S. Cl. CPC A24F 40/30; A24F 40/10; A24F 40/20; A24F 40/465; A24F 40/485; A24F 40/60; H05B 6/105; H05B 6/36

(57) ABSTRACT

An aerosol-generating system is provided, including: first and second aerosol-generating articles including first and second aerosol-forming substrates, respectively; and a hybrid aerosol-generating device including a main body including a power supply and being arranged at a distal end of the device, a top portion including a cavity including a proximal substrate receiving portion to receive the first article, a distal substrate receiving portion to receive the second article, and an airflow channel along a longitudinal axis of the cavity, the top portion arranged at a proximal end of the device, and an induction coil extending parallel to a longitudinal axis of the hybrid device over the proximal substrate receiving portion and over the distal substrate receiving portion, the proximal substrate receiving portion being configured to receive the article including a solid aerosol-forming substrate and the distal substrate receiving portion being configured to receive a cartridge including a liquid aerosol-forming substrate.

The present invention relates to a hybrid aerosol-generating device and to a system.

It is known to provide a hybrid aerosol-generating device for generating an inhalable vapor. Such devices may heat two different aerosol-forming substrates to a temperature at which one or more components of the aerosol-forming substrates are volatilised without burning the aerosol-forming substrates. Aerosol-forming substrate may be provided as part of an aerosol-generating article or as part of a cartridge. One or more of the aerosol-generating article and the cartridge may be inserted into a cavity, such as a heating chamber, of the aerosol-generating device. An induction coil may be arranged in or around the heating chamber for heating the aerosol-forming substrate once the aerosol-forming substrate is inserted into the heating chamber of the aerosol-generating device. The additional aerosol-forming substrate may be vaporized in the aerosol-generating device to form a hybrid aerosol-generating device.

It would be desirable to have a more versatile hybrid aerosol-generating device. It would be desirable to have a more compact hybrid aerosol-generating device. It would be desirable to have a less complex hybrid aerosol-generating device. It would be desirable to have a hybrid aerosol-generating device with improved airflow through the two different aerosol-forming substrates.

According to an embodiment of the invention there is provided a hybrid aerosol-generating device. The aerosol-generating device may comprise a main body. The main body may comprise a power supply. The main body may be arranged at a distal end of the hybrid aerosol-generating device. The aerosol-generating device may further comprise a top portion. The top portion may comprise a cavity. The cavity may comprise a proximal substrate receiving portion configured to receive a first aerosol-forming substrate. The cavity may comprise a distal substrate receiving portion configured to receive a second aerosol-forming substrate. The first aerosol-forming substrate may be different from the second aerosol-forming substrate. The top portion may be arranged at a proximal end of the hybrid aerosol-generating device. The hybrid aerosol-generating device may further comprise an induction coil. The induction coil may extend parallel to a longitudinal axis of the hybrid aerosol-generating device at least partly over the proximal substrate receiving portion and at least partly over the distal substrate receiving portion.

According to an embodiment of the invention there is provided a hybrid aerosol-generating device. The aerosol-generating device comprises a main body. The main body comprises a power supply. The main body is arranged at a distal end of the hybrid aerosol-generating device. The aerosol-generating device further comprises a top portion. The top portion comprises a cavity. The cavity comprises a proximal substrate receiving portion configured to receive a first aerosol-forming substrate. The cavity comprises a distal substrate receiving portion configured to receive a second aerosol-forming substrate. The first aerosol-forming substrate is different from the second aerosol-forming substrate. The top portion is arranged at a proximal end of the hybrid aerosol-generating device. The hybrid aerosol-generating device further comprises an induction coil. The induction coil extends parallel to a longitudinal axis of the hybrid aerosol-generating device at least partly over the proximal substrate receiving portion and at least partly over the distal substrate receiving portion.

According to an embodiment of the invention there is provided an aerosol-generating system. The aerosol-generating system may comprise a first aerosol-generating article comprising a first aerosol-forming substrate. The aerosol-generating system may comprise a second aerosol-generating article comprising a second aerosol-forming substrate. The first aerosol-forming substrate may be different from the second aerosol-forming substrate. The aerosol-generating system may comprise a hybrid aerosol-generating device. The hybrid aerosol-generating device may comprise a main body. The main body may comprise a power supply. The main body may be arranged at a distal end of the hybrid aerosol-generating device. The hybrid aerosol-generating device may comprise a top portion. The top portion may comprise a cavity. The cavity may comprise a proximal substrate receiving portion configured to receive the first aerosol-generating article. The cavity may comprise a distal substrate receiving portion configured to receive the second aerosol-generating article. The cavity may further comprise an airflow channel extending along a longitudinal axis of the cavity. The top portion may be arranged at a proximal end of the hybrid aerosol-generating device. The hybrid aerosol-generating device may further comprise an induction coil. The induction coil may extend parallel to a longitudinal axis of the hybrid aerosol-generating device. The induction coil may extend at least partly over the proximal substrate receiving portion and at least partly over the distal substrate receiving portion.

According to an embodiment of the invention there is provided an aerosol-generating system. The aerosol-generating system comprises a first aerosol-generating article comprising a first aerosol-forming substrate. The aerosol-generating system comprises a second aerosol-generating article comprising a second aerosol-forming substrate. The first aerosol-forming substrate is different from the second aerosol-forming substrate. The aerosol-generating system comprises a hybrid aerosol-generating device. The hybrid aerosol-generating device comprises a main body. The main body comprises a power supply. The main body is arranged at a distal end of the hybrid aerosol-generating device. The hybrid aerosol-generating device comprises a top portion. The top portion comprises a cavity. The cavity comprises a proximal substrate receiving portion configured to receive the first aerosol-generating article. The cavity comprises a distal substrate receiving portion configured to receive the second aerosol-generating article. The cavity further comprises an airflow channel extending along a longitudinal axis of the cavity. The top portion is arranged at a proximal end of the hybrid aerosol-generating device. The hybrid aerosol-generating device further comprises an induction coil. The induction coil extends parallel to a longitudinal axis of the hybrid aerosol-generating device. The induction coil extends at least partly over the proximal substrate receiving portion and at least partly over the distal substrate receiving portion.

Providing the induction coil extending at least partly over the proximal substrate receiving portion and at least partly over the distal substrate receiving portion facilitates that both a first aerosol-forming substrate received in the proximal substrate receiving portion as well as a second aerosol-forming substrate received in the distal substrate receiving portion may be heated at the same time. Further, both the first and second aerosol-forming substrates may be heated with the (single) induction coil. Preferably, the aerosol-generating device only comprises a single induction coil. This simplifies the device.

The induction coil may be controlled by a controller to heat the first and second aerosol-forming substrates at the same time. Alternatively, electrical contacts of the induction coil or at least one electrical contact of the induction coil may be configured as sliding contacts. The sliding contacts may be configured to slide in an axial direction therefore enabling contacting the induction coil at different points. This may enable that only party of the induction coil may be subjected to an alternating current. This in turn may create heating zones. Exemplarily, a first heating zone may cover the area of the proximal substrate receiving portion and a second heating zone may cover the area of the distal substrate receiving portion. The controller may thus control heating of the first and second substrates independent from each other. Alternatively or additionally, more than two electrical contacts for the induction coil may be provided at fixed locations along the axial length of the induction coil. These contacts may enable predefined heating zones such as a first heating zone covering the area of the proximal substrate receiving portion and a second heating zone covering the area of the distal substrate receiving portion. The controller may control activation of the induction in the area of the first heating zone independent of the second heating zone. The controller may even be configured to supply currents of different frequency or strength to the different electrical contacts thereby optimizing the heat generated in the different heating zones. This may be beneficial if different heating regimes may be desired for the first and second aerosol-forming substrates.

As used herein, the terms ‘proximal’, ‘distal’, ‘downstream’ and ‘upstream’ are used to describe the relative positions of components, or portions of components, of the aerosol-generating device in relation to the direction in which a user draws on the aerosol-generating device during use thereof.

The main body may be arranged at a distal end of the aerosol-generating device. The main body may be arranged distal of the top portion. The main body may comprise the controller as described in more detail below. The main body may be arranged in direct abutment to the top portion. The main body may have the same diameter as the top portion. The main body may have a circular or oval cross-section. The main body may be configured to be held by a user. The main body may have a main body housing facing the ambient environment. The main body housing may contain the further components of the main body, particularly the power supply and the controller.

The aerosol-generating device may comprise electric circuitry. The electric circuitry may comprise a microprocessor, which may be a programmable microprocessor. The microprocessor may be part of a controller. The electric circuitry may be arranged in the main body. The electric circuitry may comprise further electronic components. The electric circuitry may be configured to regulate a supply of power to the induction coil. Power may be supplied to the induction coil continuously following activation of the aerosol-generating device or may be supplied intermittently, such as on a puff-by-puff basis. The power may be supplied to the induction coil in the form of pulses of electrical current.

The power supply may be configured as a battery, particularly as a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the induction coil.

The top portion may be arranged at a proximal end of the aerosol-generating device. The top portion may be arranged proximal of the main body. The top portion may be arranged in direct abutment to the main body. The top portion may have the same diameter as the main body. The top portion may have a circular or oval cross-section. The top portion may be configured to be held by a user. The top portion may have a top portion housing facing the ambient environment.

The top portion may be configured as a mouth end through which in use an aerosol exits the aerosol-generating device and is delivered to a user. The mouth end may also be referred to as the proximal end. In use, a user draws on the proximal or mouth end of the aerosol-generating device in order to inhale an aerosol generated by the aerosol-generating device. Alternatively, a user may directly draw on an aerosol-generating article inserted into an opening at the proximal end of the aerosol-generating device. The opening at the proximal end may be an opening of the cavity. The cavity may be configured to receive the aerosol-generating article. The cavity may additionally or alternatively be configured to receive a cartridge. The cavity may be configured to receive both the aerosol-generating article at the cavity. The cavity may be configured to receive the aerosol-generating article via the opening at the proximal end. The cavity may be configured to receive the cartridge via a further opening such as a lateral door as described in more detail below. Alternatively, the cavity may be configured to receive both the cavity and the aerosol-generating article via the opening at the proximal end. As a further alternative, the cavity may be configured to receive the aerosol-generating article via the further opening and the cartridge via the opening at the proximal end.

The cartridge is preferably configured as an aerosol-generating cartridge comprising a liquid aerosol-forming substrate.

The cavity of the aerosol-generating device may have an open end at the opening at the proximal end into which the aerosol-generating article and/or the cartridge is inserted. The cavity may have a closed end opposite the open end. The closed end may be the base of the cavity. The closed end may be closed except for the provision of air apertures arranged in the base. The base of the cavity may be flat. The base of the cavity may be circular. The base of the cavity may be arranged upstream/distal of the cavity. The open end may be arranged downstream/proximal of the cavity. The cavity may have an elongate extension. The cavity may have a longitudinal central axis. A longitudinal direction may be the direction extending between the open and closed ends along the longitudinal central axis. The longitudinal central axis of the cavity may be parallel to the longitudinal axis of the aerosol-generating device.

The cavity may be configured as a heating chamber. The cavity may have a cylindrical shape. The cavity may have a hollow cylindrical shape. The cavity may have a shape corresponding to the shape of the aerosol-generating article to be received in the cavity. The cavity may have a circular cross-section. The cavity may have an elliptical or rectangular cross-section. The cavity may have an inner diameter corresponding to the outer diameter of the aerosol-generating article.

Providing a cavity comprising an airflow channel extending along a central longitudinal axis of the cavity allows to use both the aerosol-generating article comprising the solid aerosol-generating substrate and the aerosol-generating article comprising the liquid aerosol-generating substrate either in the distal or in the proximal substrate receiving portion. This may improve flexibility of usage of the device.

The proximal end or mouth end or top portion of the aerosol-generating device may also be referred to as the downstream end and the distal end or main body of the aerosol-generating device may also be referred to as the upstream end. Components, or portions of components, of the aerosol-generating device may be described as being upstream or downstream of one another based on their relative positions between the proximal, downstream or mouth end and the distal or upstream end of the aerosol-generating device.

The proximal substrate receiving portion may be arranged proximal of the distal substrate receiving portion. The proximal substrate receiving portion may be arranged downstream of the distal substrate receiving portion. The proximal substrate receiving portion may be denoted as downstream substrate receiving portion. The distal substrate receiving portion may be denoted as upstream substrate receiving portion. A longitudinal central axis of the proximal substrate receiving portion may be identical to a longitudinal central axis of the distal substrate receiving portion. In other words, the proximal substrate receiving portion and the distal substrate receiving portion may be aligned on a shared longitudinal central axis. This shared longitudinal central axis is preferably a longitudinal central axis of the cavity. This shared longitudinal central axis is preferably a longitudinal central axis of the aerosol-generating device.

The hybrid aerosol-generating device can be used with just a single aerosol-forming substrate (which in this case may be received in the proximal substrate receiving portion or in the distal substrate receiving portion). In this case, the hybrid aerosol-generating device is configured as a hybrid aerosol-generating device but in fact used primarily as a non-hybrid device for aerosolization of one type of aerosol-forming substrate. The use of a second different aerosol-forming substrate is optional. Hence, the aerosol-generating device can be transformed from an aerosol-generating device using only a first aerosol-forming substrate to a hybrid aerosol-generating device using also a second different aerosol-forming substrate.

The first aerosol-forming substrate is preferably a solid aerosol-forming substrate and the second aerosol-forming substrate is preferably a liquid aerosol-forming substrate. Alternatively, the first aerosol-forming substrate may be a liquid aerosol-forming substrate and the second aerosol-forming substrate may be a solid aerosol-forming substrate.

One or both of the first aerosol-forming substrate and the second aerosol-forming substrate may comprise, preferably may be, a heat-not-burn tobacco substrate as described in the following. One or both of the first aerosol-forming substrate and the second aerosol-forming substrate may comprise, preferably may be, a solid aerosol-forming substrate as described in the following. The solid aerosol-forming substrate may comprise nicotine. Alternatively, the solid aerosol-forming substrate may be nicotine-free. One or both of the first aerosol-forming substrate and the second aerosol-forming substrate may comprise, preferably may be, a botanical substrate. One or both of the first aerosol-forming substrate and the second aerosol-forming substrate may comprise Cannabidiol (CBD) or Tetrahydrocannabinol (THC) for medical use. One or both of the first aerosol-forming substrate and the second aerosol-forming substrate may comprise, preferably may be, a gel-based substrate as described in the following. One or both of the first aerosol-forming substrate and the second aerosol-forming substrate may comprise, preferably may be, a liquid aerosol-substrate as described in the following.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of an aerosol-generating article or smoking article.

The solid aerosol-forming substrate may comprise a tobacco-containing material containing volatile tobacco flavour compounds which are released from the substrate upon heating. The aerosol-forming substrate may comprise a non-tobacco material. The aerosol-forming substrate may comprise an aerosol former that facilitates the formation of a dense and stable aerosol. Examples of suitable aerosol formers are glycerine and propylene glycol.

If the aerosol-forming substrate is a solid aerosol-forming substrate, the solid aerosol-forming substrate may comprise, in some embodiments, one or more of: powder, granules, pellets, shreds, spaghettis, strips or sheets containing one or more of: herb leaf, tobacco leaf, fragments of tobacco ribs, reconstituted tobacco, homogenised tobacco, extruded tobacco, cast leaf tobacco and expanded tobacco. The solid aerosol-forming substrate may be in loose form, or may be provided in a suitable container or cartridge. Optionally, the solid aerosol-forming substrate may contain additional tobacco or non-tobacco volatile flavour compounds, to be released upon heating of the substrate. The solid aerosol-forming substrate may also contain capsules that, for example, include the additional tobacco or non-tobacco volatile flavour compounds and such capsules may melt during heating of the solid aerosol-forming substrate.

As used herein, homogenised tobacco refers to material formed by agglomerating particulate tobacco. Homogenised tobacco may be in the form of a sheet. Homogenised tobacco material may have an aerosol-former content of greater than 5% on a dry weight basis. Homogenised tobacco material may alternatively have an aerosol former content of between 5% and 30% by weight on a dry weight basis. Sheets of homogenised tobacco material may be formed by agglomerating particulate tobacco obtained by grinding or otherwise combining one or both of tobacco leaf lamina and tobacco leaf stems. Alternatively, or in addition, sheets of homogenised tobacco material may comprise one or more of tobacco dust, tobacco fines and other particulate tobacco by-products formed during, for example, the treating, handling and shipping of tobacco. Sheets of homogenised tobacco material may comprise one or more intrinsic binders, that is tobacco endogenous binders, one or more extrinsic binders, that is tobacco exogenous binders, or a combination thereof to help agglomerate the particulate tobacco; alternatively, or in addition, sheets of homogenised tobacco material may comprise other additives including, but not limited to, tobacco and non-tobacco fibres, aerosol-formers, humectants, plasticisers, flavourants, fillers, aqueous and non-aqueous solvents and combinations thereof.

Optionally, the solid aerosol-forming substrate may be provided on or embedded in a thermally stable carrier. The carrier may take the form of powder, granules, pellets, shreds, spaghettis, strips or sheets. Alternatively, the carrier may be a tubular carrier having a thin layer of the solid substrate deposited on its inner surface, or on its outer surface, or on both its inner and outer surfaces. Such a tubular carrier may be formed of, for example, a paper, or paper like material, a non-woven carbon fibre mat, a low mass open mesh metallic screen, or a perforated metallic foil or any other thermally stable polymer matrix.

In a particularly preferred embodiment, the aerosol-forming substrate comprises a gathered crimpled sheet of homogenised tobacco material. As used herein, the term ‘crimped sheet’ denotes a sheet having a plurality of substantially parallel ridges or corrugations. Preferably, when the aerosol-generating article has been assembled, the substantially parallel ridges or corrugations extend along or parallel to the longitudinal axis of the aerosol-generating article. This advantageously facilitates gathering of the crimped sheet of homogenised tobacco material to form the aerosol-forming substrate. However, it will be appreciated that crimped sheets of homogenised tobacco material for inclusion in the aerosol-generating article may alternatively or in addition have a plurality of substantially parallel ridges or corrugations that are disposed at an acute or obtuse angle to the longitudinal axis of the aerosol-generating article when the aerosol-generating article has been assembled. In certain embodiments, the aerosol-forming substrate may comprise a gathered sheet of homogenised tobacco material that is substantially evenly textured over substantially its entire surface. For example, the aerosol-forming substrate may comprise a gathered crimped sheet of homogenised tobacco material comprising a plurality of substantially parallel ridges or corrugations that are substantially evenly spaced-apart across the width of the sheet.

The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

The aerosol-forming substrate is a substrate capable of releasing volatile compounds that can form an aerosol. The volatile compounds may be released by heating the aerosol-forming substrate. The aerosol-forming substrate may comprise plant-based material. The aerosol-forming substrate may comprise tobacco. The aerosol-forming substrate may comprise a tobacco-containing material containing volatile tobacco flavour compounds, which are released from the aerosol-forming substrate upon heating. The aerosol-forming substrate may alternatively comprise a non-tobacco-containing material. The aerosol-forming substrate may comprise homogenised plant-based material.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Aerosol formers may be polyhydric alcohols or mixtures thereof, such as triethylene glycol, 1,3-butanediol and glycerine. The aerosol-former may be propylene glycol. The aerosol former may comprise both glycerine and propylene glycol.

If the aerosol-forming substrate is provided as a liquid aerosol-forming substrate, the liquid aerosol-forming substrate may comprise other additives and ingredients, such as flavourants. The liquid aerosol-forming substrate may comprise water, solvents, ethanol, plant extracts and natural or artificial flavours. The liquid aerosol-forming substrate may comprise nicotine. The liquid aerosol-forming substrate may have a nicotine concentration of between about 0.5% and about 10%, for example about 2%. The liquid aerosol-forming substrate may be contained in a liquid storage portion of the aerosol-generating article, in which case the aerosol-generating article may be denoted as a cartridge. The cartridge is preferably configured as a removable cartridge. A removable cartridge can be replaced with a fresh cartridge when the liquid aerosol-forming substrate is depleted.

The cartridge may comprise a liquid retention material or a tank containing or being adapted for containing a liquid aerosol-forming substrate. As used herein, the term ‘liquid retention material’ refers to a high retention or high release material (HRM) for storing a liquid. The liquid retention material is configured to intrinsically retain at least a portion of the liquid, which in turn is not available for aerosolization before having left the retention. Using a liquid retention material reduces the risk of spill in case of failure or cracks of the cartridge due to the liquid aerosol-forming substrate being safely held in the retention material. Advantageously, this allows the aerosol-generating article to be leak proof.

The aerosol-generating article may be provided comprising an aerosol-forming substrate and a susceptor for heating the aerosol-forming substrate. The susceptor may comprise a first susceptor material and a second susceptor material, the first susceptor material being disposed in intimate physical contact with the second susceptor material. The second susceptor material preferably has a Curie temperature that is lower than 500° C. The first susceptor material is preferably used primarily to heat the susceptor when the susceptor is placed in a fluctuating electromagnetic field. Any suitable material may be used. For example, the first susceptor material may be aluminium, or may be a ferrous material such as a stainless steel. The second susceptor material is preferably used primarily to indicate when the susceptor has reached a specific temperature, that temperature being the Curie temperature of the second susceptor material. The Curie temperature of the second susceptor material can be used to regulate the temperature of the entire susceptor during operation. Thus, the Curie temperature of the second susceptor material should be below the ignition point of the aerosol-forming substrate. Suitable materials for the second susceptor material may include nickel and certain nickel alloys.

In preferred embodiments the aerosol-generating article may comprise a plurality of elements assembled within a wrapper in the form of a rod having a mouth end and a distal end upstream from the mouth end, the plurality of elements including the aerosol-forming substrate located at or towards the distal end of the rod. Preferably, the aerosol-forming substrate is a solid aerosol-forming substrate. Preferably, the susceptor is an elongate susceptor having a width of between 3 mm and 6 mm and a thickness of between 10 micrometres and 200 micrometres. The susceptor is preferably located within the aerosol-forming substrate. It is particularly preferred that an elongate susceptor is positioned in a radially central position within the aerosol-forming substrate, preferably such that it extends along the longitudinal axis of the aerosol-forming substrate. The length of an elongate susceptor is preferably between 8 mm and 15 mm, for example between 10 mm and 14 mm, for example about 12 mm or 13 mm.

The cartridge may comprise a hollow tubular susceptor arrangement as disclosed in EP21203770.9, the content of which concerning the structural features of the cartridge is incorporated herein by reference. The cartridge may comprise a hollow tubular wick element. The hollow tubular wick element may coaxially circumscribe the susceptor arrangement. The cartridge may comprise a hollow tubular liquid storage portion. The hollow tubular liquid storage portion may coaxially circumscribe the wick element.

The cartridge may comprise an airflow path extending along a longitudinal center axis within the hollow tubular susceptor arrangement. The airflow path of the cartridge may extend from a distal end of the cartridge to a proximal end of the cartridge. The distal end of the cartridge may be the upstream end. The proximal end of the cartridge may be the downstream end.

As used herein, the term ‘aerosol-generating article’ refers to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable. Preferably, the aerosol-forming substrate contained in the aerosol-generating article is a solid aerosol-forming substrate.

The aerosol-generating article may be substantially cylindrical in shape. The aerosol-generating article may be substantially elongate. The aerosol-generating article may have a length and a circumference substantially perpendicular to the length. The aerosol-generating article may be substantially rod shaped. The aerosol-forming substrate may be substantially cylindrical in shape. The aerosol-forming substrate may be substantially elongate. The aerosol-forming substrate may also have a length and a circumference substantially perpendicular to the length. The aerosol-forming substrate may be substantially rod shaped.

The aerosol-generating article may have a total length between approximately 30 mm and approximately 100 mm. The aerosol-generating article may have an external diameter between approximately 5 mm and approximately 12 mm. The aerosol-generating article may comprise a filter plug. The filter plug may be located at a downstream end of the aerosol-generating article. The filter plug may be a cellulose acetate filter plug. The filter plug is approximately 7 mm in length in one embodiment, but may have a length of between approximately 5 mm to approximately 10 mm.

In one embodiment, the aerosol-generating article has a total length of approximately 45 mm. The aerosol-generating article may have an external diameter of approximately 7.2 mm. Further, the aerosol-forming substrate may have a length of approximately 10 mm. Alternatively, the aerosol-forming substrate may have a length of approximately 12 mm. Further, the diameter of the aerosol-forming substrate may be between approximately 5 mm and approximately 12 mm. The aerosol-generating article may comprise an outer paper wrapper. Further, the aerosol-generating article may comprise a separation between the aerosol-forming substrate and the filter plug. The separation may be approximately 18 mm, but may be in the range of approximately 5 mm to approximately 25 mm.

As used herein, an ‘aerosol-generating device’ relates to a device that interacts with an aerosol-forming substrate to generate an aerosol. The aerosol-forming substrate may be part of an aerosol-generating article, for example part of a smoking article. The aerosol-forming substrate may be part of a cartridge. The aerosol-forming substrate part of an aerosol-generating article as well as of the cartridge. As described herein, it is particularly preferred to provide a first aerosol-forming substrate and a different second-forming substrate which are contained in an aerosol-generating article and a cartridge, respectively. An aerosol-generating device may be a smoking device that interacts with an aerosol-forming substrate to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and an induction coil as described herein.

As used herein with reference to the present invention, the term ‘smoking’ with reference to a device, article, system, substrate, or otherwise does not refer to conventional smoking in which an aerosol-forming substrate is fully or at least partially combusted. The aerosol-generating device of the present invention is arranged to heat the aerosol-forming substrate to a temperature below a combustion temperature of the aerosol-forming substrate, but at or above a temperature at which one or more volatile compounds of the aerosol-forming substrate are released to form an inhalable aerosol.

The proximal substrate receiving portion may be configured to receive an aerosol-generating article comprising a solid aerosol-forming substrate. The distal substrate receiving portion may be configured to receive a cartridge comprising a liquid aerosol-forming substrate. Alternatively, the proximal substrate receiving portion may be configured to receive a cartridge comprising a liquid aerosol-forming substrate. The distal substrate receiving portion may be configured to receive an aerosol-generating article comprising a solid aerosol-forming substrate.

The receiving portion configured to receive the cartridge may be configured to laterally receive the cartridge. Preferably, the distal substrate receiving portion is configured to laterally receive the cartridge.

The respective receiving portion may be configured such that a user may insert the cartridge into the respective receiving portion in a lateral direction. When the aerosol-forming substrate contained in the cartridge is spent, a user may remove the spent cartridge in a reverse lateral direction and insert a fresh cartridge.

The receiving portion configured to receive the aerosol-generating article may be configured to axially receive the aerosol-generating article. Preferably, the proximal substrate receiving portion is configured to axially receive the aerosol-generating article.

The respective receiving portion may be configured such that a user may insert the aerosol-generating article into the respective receiving portion in an axial direction. When the aerosol-forming substrate contained in the aerosol-generating article is spent, a user may remove the spent aerosol-generating article in a reverse axial direction and insert a fresh aerosol-generating article.

The term ‘axial/axially’ may denote a direction along or parallel to a longitudinal central axis of the aerosol-generating device. The term ‘lateral/laterally’ may denote a direction perpendicular to a longitudinal central axis of the aerosol-generating device.

A housing portion of the top portion may be configured axially movable relative to the distal substrate receiving portion to enable opening and closing of the distal substrate receiving portion. The movable housing portion may also be denoted as first housing portion.

The top portion may comprise a second housing portion which is stationary with respect to the main body. The first housing portion of the top portion may be configured movable with respect to the second housing portion of the top portion. The second housing portion may comprise the distal substrate receiving portion. The distal substrate receiving portion may be made accessible by the movement of the first housing portion with respect to the second housing portion.

Particularly, a lateral opening may be created in the distal substrate receiving portion by the relative movement of the first housing portion with respect to the second housing portion. More specifically, a user may axially move the first housing portion away from the second housing portion such that a lateral opening to the distal substrate receiving portion opens. A user can then insert a fresh cartridge into the distal substrate receiving portion or remove a spent cartridge from the distal substrate receiving portion (or both).

The distal substrate receiving portion may be formed by a semi-tube. The semi-tube may be a tube with a cut-out lateral opening. The cut-out lateral opening may enable the lateral insertion and removal of cartridges into/from the distal substrate receiving portion as described herein. The distal substrate receiving portion, particularly the cut-out lateral opening of the distal substrate receiving portion, may be closed when the first housing portion is in a first position. In the first position of the first housing portion, the first housing portion may be in a first position near the main body. This first position may be a distal position of the first housing portion with respect to the main body. The first position may also be denoted as a retracted position. When the first housing portion is moved relative to the second housing portion, the first housing portion may be in a second position away from the main body. The second position may be a proximal position of the first housing portion with respect to the main body. The second position may be denoted as expanded position.

The first housing portion of the top portion may be sliding the connected with the second housing portion of the top portion. The first housing portion may be axially slidable with respect to the second housing portion. The first housing portion may comprise a first sliding element and the second housing portion may comprise a second sliding element, wherein the first and second sliding elements may interact enable a sliding movement between the first housing portion and the second housing portion. Exemplarily, the first housing portion may comprise a groove and the second housing portion may comprise a protrusion or vice versa. The protrusion may be arranged in the groove to facilitate the sliding movement between the first housing portion and the second housing portion.

One or both of the first housing portion and the second housing portion may comprise a guiding element to guide the sliding movement between the first housing portion and the second housing portion. The guiding element and the first and second sliding elements may be one the same element to enable the sliding movement between the first housing portion and the second housing portion. The guiding element may prevent a rotation of the first housing portion relative to the second housing portion.

The top portion may comprise a locking element. The locking element may be configured to prevent detachment of the first housing portion from the distal substrate receiving portion during axial movement of the housing portion relative to the distal substrate receiving portion. The locking element may prevent detachment of the first housing portion of the top portion from the second housing portion of the top portion. The locking element may comprise a stop. The stop may be arranged in the groove discussed above such that the protrusion stops when reaching the stop. The locking element may limit the axial movement of the first housing portion relative to the second housing portion.

One or both of the first housing portion and the distal substrate receiving portion may comprise a biasing element. The biasing element may be configured to bias the first housing portion away from the distal substrate receiving portion. The second housing portion may comprise the biasing element.

The biasing element may be a spring. The biasing element may automatically move the first housing portion into the second position described above such that the user can access the distal substrate receiving portion.

One or both of the first housing portion and the distal substrate receiving portion may comprise a releasing element. The releasing element may be configured to release the biasing element upon a user interaction.

The releasing element may be a button. The releasing element may be arranged on an outer periphery of the first housing portion of the second housing portion such that a user can easily access the releasing element. The releasing element may hold the first housing portion in the first position. Upon releasing the first housing portion from the first position by activating the releasing element, the first housing portion may be automatically moved to the second position due to the biasing force of the biasing element. A user may return the first housing portion and the first position against the biasing force of the biasing element. Upon activating the releasing element again, the first housing portion may be held in the first position again.

The distal substrate receiving portion may comprise a door configured to enable lateral insertion of the cartridge. The door may be part of the second housing portion of the top portion.

The door may be slidably mounted. The slidable mounting of the door may enable a sliding movement to enable the lateral insertion of the cartridge. The door may be slidably mounted at the second housing portion of the top portion. The door may be slidably mounted such that door may slide into the second housing portion during the sliding movement. Alternatively, the door may be hingely mounted at the second housing portion or at the distal substrate receiving portion. In other words, the door may comprise a hinge such that the door can be swung open to enable lateral access to the distal substrate receiving portion.

A sealing element may be provided at or adjacent the door. The sealing element may seal to door when the door is closed. The sealing element may hermetically seal the door when the door is closed. The sealing element may reduce or prevent air from escaping through the door or next to the door. As a result, the airflow channel adjacent the door may be unperturbed by the door, particularly the airflow channel through the distal substrate receiving portion. The sealing element may comprise or may be configured as an O-ring. The sealing element may comprise or may be configured as a fitted sealing member.

In a further embodiment, the door may include a part or a section of the induction coil. The induction coil may be partly housed in the door. A part of the induction coil may be arranged in the door. One or both of the electrical contacts of the induction coil may be connected with an electric circuit. The electric circuit may be open when the door is open. The electric circuit may be closed when the doors closed. The electric circuit may electrically connect the induction coil with one or both of the controller and the power supply. The door may be configured to have a double functionality. A first functionality may be to enable insertion and removal of a cartridge. A second functionality may be to enable operation of the induction coil the closing the electric circuit and disabling operation of the induction coil by opening of the electric circuit. Connection elements may be provided at one or both the door and the distal substrate receiving portion. The connection element may be configured to mount the door. The connection element may further enable transfer of electrical energy to the door. The connection element may be configured to allow transfer of electrical energy to the door when the door is closed. The connection element may comprise spring loaded pins or tabs that engage with corresponding conductive tabs in the door or a door frame at the distal substrate receiving portion to allow transfer of electrical energy to the door when the door is closed. The connection element may hold the door in a closed state after closing of the door. The connection element may comprise a retention element to hold the door in a closed state after closing of the door. The induction coil may fully extend over one or both of the distal substrate receiving portion and the proximal substrate receiving portion.

The full length of the distal substrate receiving portion and the proximal substrate receiving portion may thus be heated by the single induction coil.

One or both of the main body and the distal substrate receiving portion may comprise an air inlet to allow ambient air to be drawn into an airflow channel of the hybrid aerosol-generating device. The air inlet may also be arranged in the top portion, preferably in the second housing portion of the top portion. The air inlet may be arranged in a sidewall of main body or of the top portion.

The airflow channel may comprise a first portion fluidly connecting the air inlet with the distal substrate receiving portion.

The first portion of the airflow channel may comprise an upstream part and a downstream part. The downstream part may extend along a longitudinal central axis of the cavity.

Splitting the first portion in an upstream and downstream part with different orientations allows different directions of the airflow for the upstream and the downstream part. The downstream part extending along the longitudinal central axis of the cavity may lead to a central airflow through the cavity.

The upstream part may provide a fluid connection to an air inlet arranged in a non-axial orientation relative to the airflow channel. The upstream part may have a lateral extension. The upstream part may extend perpendicular to the extension of the downstream part.

Alternatively, the air inlet may be arranged at the proximal end of the top portion and fluidly connect the air inlet and the distal substrate receiving portion by a 180-degree turn in the airflow channel.

Providing a 180-degree turn in the airflow channel may allow ambient air to be drawn into the aerosol-generating device in opposite direction parallel to the hot airflow channel of the device and may pre-heat the ambient air before reaching the cavity.

The distal substrate receiving portion or the second housing portion of the top portion may comprise a second portion of the airflow channel fluidly connecting the distal substrate receiving portion with the proximal substrate receiving portion.

Beneficially, a single air inlet and a single airflow channel can thus be provided for enabling airflow through or both of the distal substrate receiving portion and the proximal substrate receiving portion. Particularly, the air may flow first through the distal substrate receiving portion and subsequently, downstream of the distal substrate receiving portion, through the proximal substrate receiving portion. A beneficial choice of first and second aerosol-forming substrates may be chosen such that an optimized aerosol is generated by the subsequent passing of the air through the distal substrate receiving portion and then the proximal substrate receiving portion.

The second portion of the airflow channel may fluidly connect the distal substrate receiving portion with the proximal substrate receiving portion via a separator element.

The separator element may be configured as a mechanical separator element. The separator element may comprise a one-way valve enabling airflow only in a direction from the distal substrate receiving portion to the proximal substrate receiving portion.

The second portion of the airflow channel may extend along a longitudinal axis of the cavity.

The longitudinal axis of the cavity is preferably a longitudinal central axis of the cavity, more preferably a longitudinal central axis of the aerosol-generating device.

The top portion may comprise a third portion of the airflow channel fluidly connecting the proximal substrate receiving portion with a proximal opening of the cavity of the top portion.

The third portion of the airflow channel may extend along the longitudinal axis of the cavity.

The airflow channel may extend along a central longitudinal axis through one or both of the first aerosol-generating article and the second aerosol-generating article. The airflow channel may extend along a central longitudinal axis parallel to the susceptor elements of the aerosol-generating articles. Providing an airflow channel extending centrally through one or both of the first aerosol-generating article may allow a simple central airflow through one or both of the aerosol-generating articles. The airflow channel may extend along a central longitudinal axis through one or both of the aerosol-generating articles if one or both of liquid and solid aerosol-generating articles may be inserted into the cavity. The airflow channel may extend along a central longitudinal axis through one or both of the aerosol-generating articles if one or both aerosol-generating articles may be inserted into the cavity. This may improve flexibility of usage of the device. The invention further relates to a system comprising the hybrid aerosol-generating device as described herein and an aerosol-generating article comprising a solid aerosol-forming substrate. The aerosol-generating article may comprise a heating element. The heating element may comprise a susceptor material.

The invention further relates to a system comprising the hybrid aerosol-generating device as described herein and an aerosol-generating article comprising a solid aerosol-forming substrate. The aerosol-generating article comprises a heating element. The heating element comprises a susceptor material.

The heating element may also be denoted as an induction heating element. The heating element is preferably not configured as a resistive heating element. The induction heating element may comprise a susceptor. Preferably, the induction heating element is configured as a susceptor. In general, a susceptor is a material that is capable of generating heat, when penetrated by an alternating magnetic field. When located in an alternating magnetic field. If the susceptor is conductive, then typically eddy currents are induced by the alternating magnetic field. If the susceptor is magnetic, then typically another effect that contributes to the heating is commonly referred to hysteresis losses. Hysteresis losses occur mainly due to the movement of the magnetic domain blocks within the susceptor, because the magnetic orientation of these will align with the magnetic induction field, which alternates. Another effect contributing to the hysteresis loss is when the magnetic domains will grow or shrink within the susceptor. Commonly all these changes in the susceptor that happen on a nano-scale or below are referred to as “hysteresis losses”, because they produce heat in the susceptor. Hence, if the susceptor is both magnetic and electrically conductive, both hysteresis losses and the generation of eddy currents will contribute to the heating of the susceptor. If the susceptor is magnetic, but not conductive, then hysteresis losses will be the only means by which the susceptor will heat, when penetrated by an alternating magnetic field. According to the invention, the susceptor may be electrically conductive or magnetic or both electrically conductive and magnetic. An alternating magnetic field generated by the induction coil heats the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate.

According to the present invention, it is particularly preferred that the single induction coil heats two separate susceptors. The first susceptor is part of the aerosol-generating article. The second susceptor as part of the cartridge. The respective susceptors may be in the form of particles distributed close to or within one or both of the first aerosol-forming substrate and the second aerosol-forming substrate.

The invention further relates to a system comprising the hybrid aerosol-generating device as described herein and a cartridge comprising a liquid aerosol-forming substrate. The cartridge may comprise a heating element. The heating element may comprise a susceptor material.

The invention further relates to a system comprising the hybrid aerosol-generating device as described herein and a cartridge comprising a liquid aerosol-forming substrate. The cartridge comprises a heating element. The heating element comprises a susceptor material.

The invention further relates to a system comprising the hybrid aerosol-generating device as described herein and an aerosol-generating article as described herein and a cartridge as described herein.

The system may further comprise the first aerosol-generating article comprising a solid or liquid aerosol-forming substrate and a heating element. The heating element may comprise a susceptor material. The system may further comprise the second aerosol-generating article comprising a solid or liquid aerosol-forming substrate and a heating element. The heating element may comprise a susceptor material.

The system may comprise two different aerosol-generating articles each comprising a solid aerosol-generating substrate. The system may comprise two different aerosol-generating articles each comprising a liquid aerosol-generating substrate. The system may comprise an aerosol-generating article comprising a solid aerosol-generating substrate and an aerosol-generating article comprising a liquid aerosol-generating substrate.

Below, there is provided a non-exhaustive list of non-limiting examples. Any one or more of the features of these examples may be combined with any one or more features of another example, embodiment, or aspect described herein.

ex1. A hybrid aerosol-generating device comprising:
a main body, wherein the main body comprises a power supply, and wherein the main body is arranged at a distal end of the hybrid aerosol-generating device;
a top portion, wherein the top portion comprises a cavity, wherein the cavity comprises a proximal substrate receiving portion configured to receive a first aerosol-forming substrate, wherein the cavity comprises a distal substrate receiving portion configured to receive a second aerosol-forming substrate, wherein the first aerosol-forming substrate is different from the second aerosol-forming substrate, and wherein the top portion is arranged at a proximal end of the hybrid aerosol-generating device;
wherein the hybrid aerosol-generating device further comprises an induction coil, and wherein the induction coil extends parallel to a longitudinal axis of the hybrid aerosol-generating device at least partly over the proximal substrate receiving portion and at least partly over the distal substrate receiving portion.

ex2. The hybrid aerosol-generating device according to example ex1, wherein the proximal substrate receiving portion is configured to receive an aerosol-generating article comprising a solid aerosol-forming substrate and the distal substrate receiving portion is configured to receive a cartridge comprising a liquid aerosol-forming substrate or wherein the proximal substrate receiving portion is configured to receive a cartridge comprising a liquid aerosol-forming substrate and the distal substrate receiving portion is configured to receive an aerosol-generating article comprising a solid aerosol-forming substrate.

ex3. The hybrid aerosol-generating device according to example ex2, wherein the receiving portion configured to receive a cartridge is configured to laterally receive the cartridge.

ex4. The hybrid aerosol-generating device according to example ex2 or ex3, wherein a housing portion of the top portion is configured axially movable relative to the distal substrate receiving portion to enable opening and closing of the distal substrate receiving portion.

ex5. The hybrid aerosol-generating device according to example ex4, wherein the top portion comprises a locking element, wherein the locking element is configured to prevent detachment of the housing portion from the distal substrate receiving portion during axial movement of the housing portion relative to the distal substrate receiving portion.

ex6. The hybrid aerosol-generating device according to any of examples ex4 and ex5, wherein one or both of the housing portion and the distal substrate receiving portion comprises a biasing element, wherein the biasing element is configured to bias the housing portion away from the distal substrate receiving portion.

ex7. The hybrid aerosol-generating device according to example ex6, wherein one or both of the housing portion and the distal substrate receiving portion comprises a releasing element, wherein the releasing element is configured to release the biasing element upon a user interaction.

ex8. The hybrid aerosol-generating device according to example ex3, wherein the distal substrate receiving portion comprises a door configured to enable lateral insertion of the cartridge.

ex9. The hybrid aerosol-generating device according to any of the preceding examples, wherein the induction coil fully extends over one or both of the distal substrate receiving portion and the proximal substrate receiving portion.

ex10. The hybrid aerosol-generating device according to any of the preceding examples, wherein the induction coil fully extends over the cavity of the top portion.

ex11. The hybrid aerosol-generating device according to any of the preceding examples, wherein one or both of the main body and the distal substrate receiving portion comprises an air inlet to allow ambient air to be drawn into an airflow channel of the hybrid aerosol-generating device.

ex12. The hybrid aerosol-generating device according to example ex11, wherein the airflow channel comprises a first portion fluidly connecting the air inlet with the distal substrate receiving portion.

ex13. The hybrid aerosol-generating device according to any of examples ex11 and ex12, wherein the distal substrate receiving portion comprises a second portion of the airflow channel fluidly connecting the distal substrate receiving portion with the proximal substrate receiving portion.

ex14. The hybrid aerosol-generating device according to example ex13, wherein the second portion of the airflow channel fluidly connects the distal substrate receiving portion with the proximal substrate receiving portion via a separator element.

ex15. The hybrid aerosol-generating device according to any of examples ex13 and ex14, wherein the second portion of the airflow channel extends along a longitudinal axis of the cavity.

ex16. The hybrid aerosol-generating device according to any of examples ex11 to ex15, wherein the top portion comprises a third portion of the airflow channel fluidly connecting the proximal substrate receiving portion with a proximal opening of the cavity of the top portion.

ex17. The hybrid aerosol-generating device according to example ex16, wherein the third portion of the airflow channel extends along a longitudinal axis of the cavity.

ex18. System comprising the hybrid aerosol-generating device according to any of examples ex1 to ex17 and an aerosol-generating article comprising a solid aerosol-forming substrate, wherein the aerosol-generating article comprises a heating element, and wherein the heating element comprises a susceptor material.

ex19. System comprising the hybrid aerosol-generating device according to any of examples ex1 to ex17 and a cartridge comprising a liquid aerosol-forming substrate, wherein the cartridge comprises a heating element, and wherein the heating element comprises a susceptor material.

ex20. System comprising the hybrid aerosol-generating device according to any of claims ex1 to ex17 and an aerosol-generating article according to claim ex18 and a cartridge according to claim ex19.

Features described in relation to one embodiment may equally be applied to other embodiments of the invention.

The invention will be further described, by way of example only, with reference to the accompanying drawings in which:

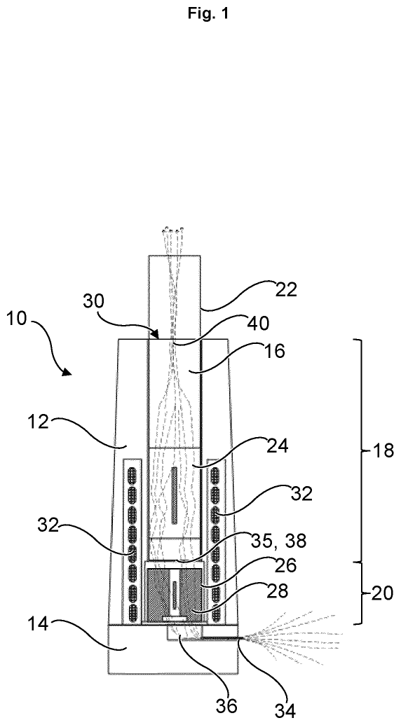

FIG. 1 shows a cross-sectional side view of an aerosol-generating device according to the present invention;

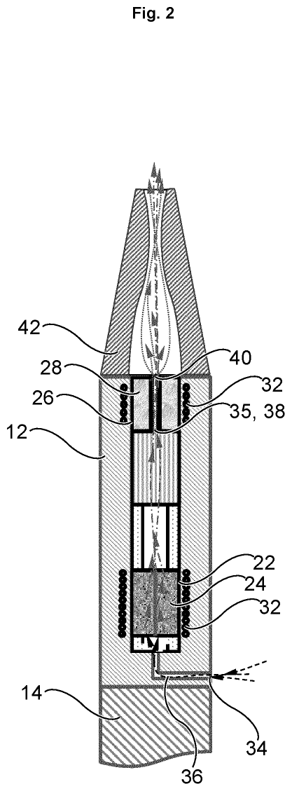

FIG. 2 shows a cross-sectional side view of an alternative aerosol-generating device;

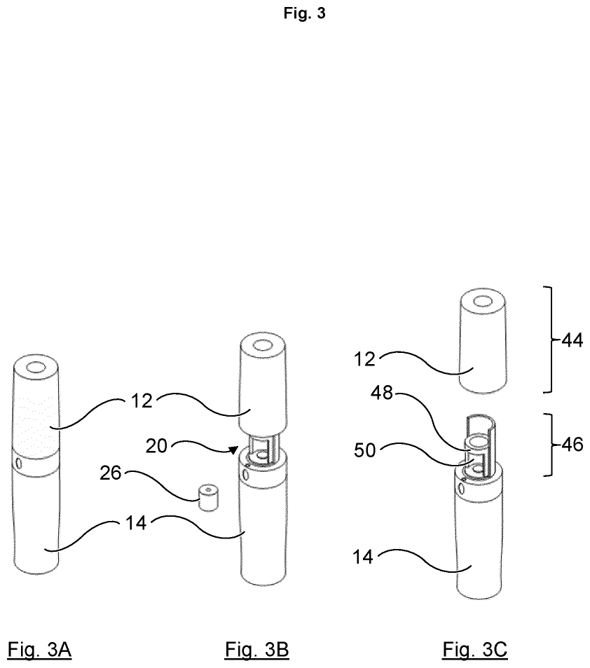

FIGS. 3A-3C show movement of parts of the aerosol-generating device;

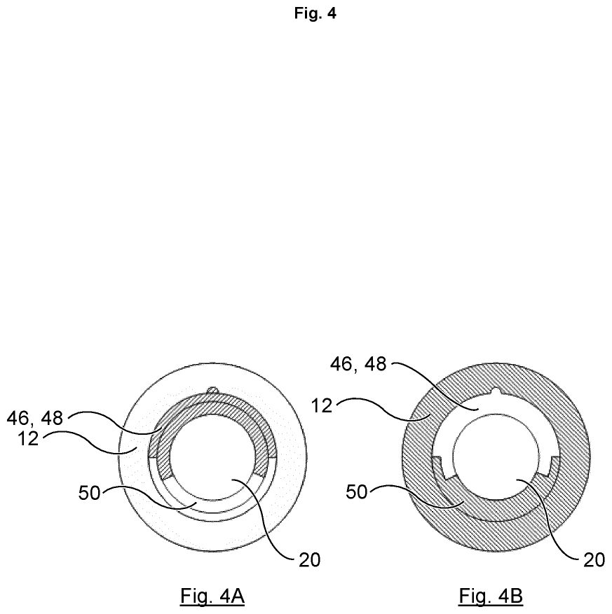

FIGS. 4A and 4B show a cross-sectional top view of the movement of parts of the aerosol-generating device;

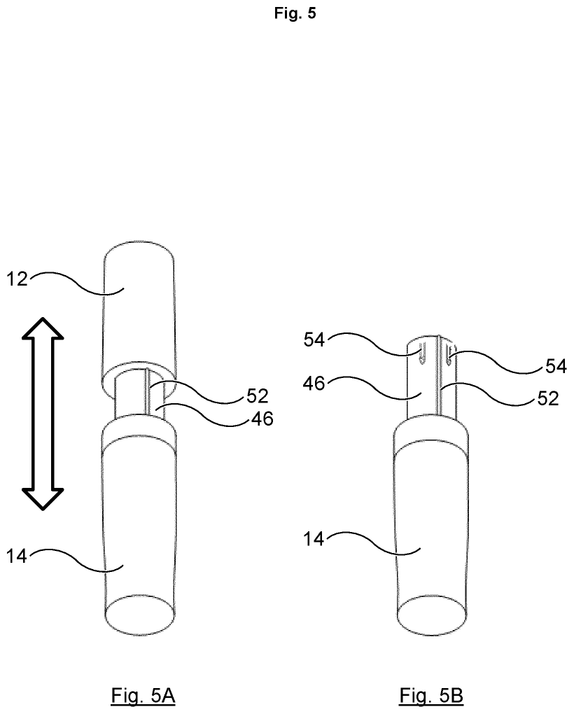

FIGS. 5A and 5B show movement of parts of the aerosol-generating device;

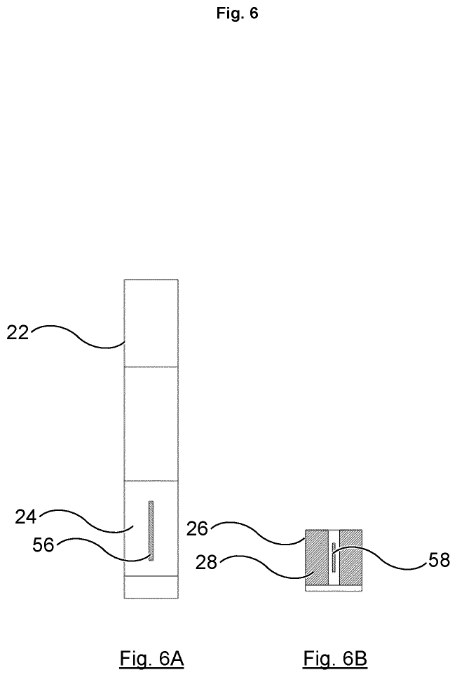

FIGS. 6A and 6B show cross-sectional side views of an aerosol-generating article and a cartridge;

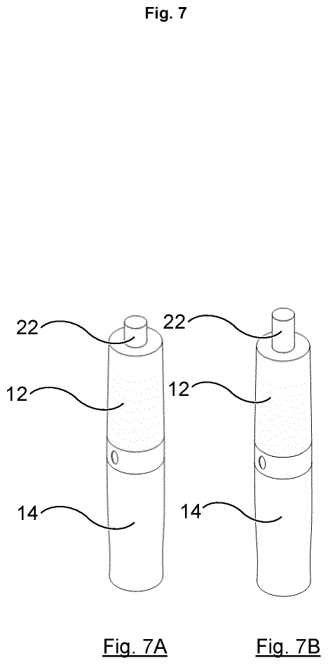

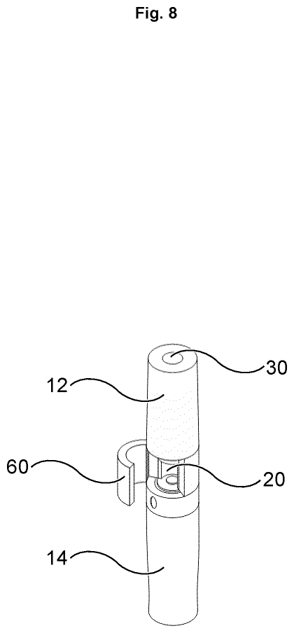

FIGS. 7A and 7B show different uses of the aerosol-generating device; and FIG. 8 shows an alternative embodiment for inserting the cartridge.

FIG. 1 shows an aerosol-generating device 10, more specifically a top portion 12 of the aerosol-generating device 10 and a main body 14 of the aerosol-generating device 10. The top portion 12 is arranged proximal of the main body 14. The top portion 12 is arranged abutting the main body 14.

The top portion 12 comprises a cavity 16. The cavity 16 has a circular cross-sectional shape. Alternatively, the cavity 16 may have a non-circular cross-section. Exemplarily, the cavity 16 may have a rectangular or non-regular shaped cross-section. The cavity 16 comprises a proximal substrate receiving portion 18 and a distal substrate receiving portion 20. The proximal substrate receiving portion 18 is configured to receive an aerosol-generating article 22 comprising a solid aerosol-forming substrate 24. The distal substrate receiving portion 20 is configured to receive a cartridge 26 comprising a liquid aerosol-forming substrate 28.

The proximal substrate receiving portion 18 and the distal substrate receiving portion 20 may have the same diameter. Alternatively, the proximal substrate receiving portion 18 and the distal substrate receiving portion 20 may have a different diameter. Exemplarily, the distal substrate receiving portion 20 may have a lower diameter than the proximal substrate receiving portion 18. This may clarify for user in which portion 18, 20 the aerosol-generating article 22 must be inserted. Alternatively or additionally, one or both of the proximal substrate receiving portion 18 and the distal substrate receiving portion 20 may have a complementary shape or a proprietary shape. The shape of one or both of the proximal substrate receiving portion 18 and the distal substrate receiving portion 20 may be such only the desired element (such as an aerosol-generating article 22 or a cartridge 26) can be inserted in the respective portion 18, 20. Exemplarily, the proximal substrate receiving portion 18 may be shaped to only receive an aerosol-generating article 22. Exemplarily, the proximal substrate receiving portion 18 may be shaped such that a cartridge 26 does not fit into the proximal substrate receiving portion 18. Exemplarily, the distal substrate receiving portion 20 may be shaped to only receive a cartridge 26. Exemplarily, the distal substrate receiving portion 20 may be shaped such that an aerosol-generating article 22 does not fit into the substrate receiving portion 20.

The cavity 16 has an open proximal end 30 into which the aerosol-generating article 22 can be inserted. Optionally, the cartridge 26 can also be inserted into the cavity 16 via the open proximal end 30 of the cavity 16. Alternative options to insert the cartridge 26 will be described in more detail below with reference to FIGS. 3 to 5 and 8.

A user can draw on a proximal end of the aerosol-generating article 22 to inhale the generated aerosol. The aerosol-generating article 22 is thus arranged proximal or downstream of the cartridge 26, which is arranged distal or upstream of the aerosol-generating article 22. Consequently, the proximal substrate receiving portion 18 is thus arranged proximal or downstream of the distal substrate receiving portion 20, which is arranged distal or upstream of the proximal substrate receiving portion 18.

The aerosol-generating device 10 further comprises a single induction coil 32. The induction coil 32 extends parallel to a longitudinal axis of the cavity 16 at least partly over the proximal substrate receiving portion 18 and at least partly over the distal substrate receiving portion 20. Preferably, the induction coil 32 extends over the axial portion of the proximal substrate receiving portion 18 in which the solid aerosol-forming substrate 24 of the aerosol-generating article 22 is arranged when the aerosol-generating article 22 is received in the proximal substrate receiving portion 18. Preferably, the induction coil 32 extends over the axial portion of the distal substrate receiving portion 20 in which the liquid aerosol-forming substrate 28 of the cartridge 26 is arranged when the cartridge 26 is received in the distal substrate receiving portion 20.

FIG. 1 further shows an air inlet 34 arranged in a sidewall of the main body 14. Alternative, the air inlet 34 may be arranged in a sidewall of the top portion 12. In both cases, the air inlet 34 is fluidly connected with a first portion 36 of an airflow channel that fluidly connects the air inlet 34 with an upstream or distal end of the distal substrate receiving portion 20.

Air can thus be drawn into and through the distal substrate receiving portion 20 via the air inlet 34 and the first portion 36 of the airflow channel. The air is preferably drawn through the distal substrate receiving portion 20 along a longitudinal central axis of the cavity 16. Downstream of the distal substrate receiving portion 20, the airflow channel comprises a second portion 38 which is fluidly connecting the distal substrate receiving portion 20 with the proximal substrate receiving portion 18. The second portion 38 of the airflow channel is preferably arranged along the longitudinal central axis of the cavity 16.

At the second portion 38 of the airflow channel, a separator element 35 such as a lateral wall having an aperture or a one-way valve may be arranged to separate the distal substrate receiving portion 20 and the proximal substrate receiving portion 18. In other words, a separator element 35 such as a lateral wall having an aperture or a one-way valve may be arranged between the distal substrate receiving portion 20 and the proximal substrate receiving portion 18. One of the cartridge 26 and the aerosol-generating article 22 may comprise parts of the separator element 35 of the entire separator element 35. The cartridge 26 and the aerosol-generating article 22 may be stacked and may have a fluidic channel therebetween. Alternatively, the cartridge 26 and the aerosol-generating article 22 may be configured connectable with each other before insertion into the cavity 16. The connection between the cartridge 26 and the aerosol-generating article 22 may be facilitated by the separator element 35.

Hence, the air is drawn into the proximal substrate receiving portion 18 after having passed through the distal substrate receiving portion 20. The airflow channel comprises a final third portion 40 which fluidly connects the proximal substrate receiving portion 18 with the open proximal end 30 of the cavity 16. The third portion 40 of the airflow channel is preferably arranged along the longitudinal central axis of the cavity 16.

FIG. 2 shows an alternative embodiment in which the order, with respect to an upstream/downstream or distal/proximal direction, of the arrangement of the aerosol-generating article 22 and the cartridge 26 is reversed. As shown in FIG. 2, the aerosol-generating article 22 is arranged in the distal substrate receiving portion 20 and the cartridge 26 is received in the proximal substrate receiving portion 18. In this embodiment, air will be drawn though the aerosol-generating article 22 first and subsequently through the cartridge 26.

In this embodiment, the air inlet 34 is exemplarily depicted to be arranged in a sidewall of the top portion 12. However, this arrangement of the air inlet 34 is illustrative and the air inlet 34 may alternatively be arranged in the main body 14 as shown in FIG. 1.

FIG. 2 shows a mouthpiece 42 as an additional element of the aerosol-generating device 10. This may be beneficial in this arrangement of the aerosol-generating article 22 and the cartridge 26, as a user cannot directly draw on the proximal end of the aerosol-generating article 22.

FIG. 2 further shows the induction coil 32 arranged around a proximal portion of the cavity 16 and arranged around a distal portion of the cavity 16. The induction coil 32 may be connected in series such that the induction coil 32 functions as a single induction coil. In this embodiment, only a single pair of electrical connections may be necessary between the induction coil 32 and the power supply. Alternatively, two distinct induction coils 32 may be provided with separate connection to the power supply. A first induction coil 32 may be arranged around a proximal portion of the cavity 16 and a second induction coil 32 may be arranged around a distal portion of the cavity 16.

FIG. 3 shows an embodiment in which the cartridge 26 can be laterally received in the distal substrate receiving portion 20. To facilitate this, the top portion 12 comprises a first housing portion 44 and a second housing portion 46 which can be moved relative to each other in a distal/proximal direction. In FIG. 3A, the first housing portion 44 is in a first position in which the top portion 12 is arranged abutting the main body 14. In FIG. 3B, the first housing portion 44 is in a second position in which the second housing portion 46 is arranged proximally distanced from the main body 14 and in which a lateral opening in the first housing portion 44 has been made accessible. In more detail, the first housing portion 44 comprises a semi-tube 48 comprising a cut-out lateral opening 50. Thereby, the cartridge 26 can be inserted into the distal substrate receiving portion 20 via the cut-out lateral opening 50. Subsequently, the first housing portion 44 can be pushed back to the first position and the aerosol-generating device 10 can be used. After the cartridge 26 is spend, this movement of the first housing portion 44 from the first position to the second position can be repeated to remove the spend cartridge 26. A fresh cartridge 26 can then be inserted again.

In all embodiments of the invention, and exemplarily described with reference to FIG. 3, the aerosol-generating device 10 may be operated with only a first aerosol-forming substrate received in the proximal substrate receiving portion 18 or with only a second aerosol-forming substrate received in the distal substrate receiving portion 20. Exemplarily, it may be desirable to only insert a solid aerosol-forming substrate 24 in the proximal substrate receiving portion 18 and to leave the distal substrate receiving portion 20 empty. In this case, air will freely flow through the distal substrate receiving portion 20, which in this case forms part of the airflow channel. Exemplarily, it may be desirable to only insert a liquid aerosol-forming substrate 28 in the distal substrate receiving portion 20 and to leave the proximal substrate receiving portion 18 empty. In this case, air will freely flow through the proximal substrate receiving portion 18, which in this case forms part of the airflow channel.

FIG. 4 shows a cross-sectional top view of the distal substrate receiving portion 20. In FIG. 4A, the second position of the second housing portion 46 of the top portion 12 is depicted. The cut-out lateral opening 50 is exposed such that a cartridge 26 can be inserted into the distal substrate receiving portion 20. In FIG. 4B, the first position of the second housing portion 46 of the top portion 12 is depicted. The cut-out lateral opening 50 is closed such that a cartridge 26 is securely held within the distal substrate receiving portion 20.

The top portion 12 may be configured as a cap. One or both of the top portion 12 and the first housing portion 44 may be configured removably attachable to the main body 14. To this end, one or both of the top portion 12 and the first housing portion 44 and the main body 14 may comprise attaching means. The attaching means may be configured as one or more of: snap-lock attaching means, bayonet-type locking means, threads, interference fit attaching means or male-female attaching means.

FIG. 5 shows an embodiment in which one or both of the top portion 12 and the first housing portion 44 cannot be detached from the main body 14. Instead, a sliding movement of the first housing portion 44 of the top portion 12 with respect to the main body 14 is facilitated to enable access to the distal substrate receiving portion 20. In more detail, FIG. 5 shows the movement of the first housing portion 44 of the top portion 12 relative to the second housing portion 46 of the top portion 12 and relative to the main body 14 of the aerosol-generating device 10. In FIG. 5A, the first housing portion 44 is in the second position. The movement of the first housing portion 44 is limited to an axial movement by the provision of a guiding element 52 at the second housing portion 46. The first housing portion 44 comprises a corresponding recess which interacts with the guiding element 52 to facilitate an axial sliding movement of the first housing portion 44 with respect to the second housing portion 46.

To prevent detachment of the first housing portion 44 of the top portion 12 from the second housing portion 46 of the top portion 12, the second housing portion 46 comprises locking elements 54. The locking elements 54 act as a stop to limit the sliding movement of the first housing portion 44 in a proximal direction.

FIG. 6A shows the aerosol-generating article 22 in more detail. The aerosol-generating article 22 is configured to be receiving in the proximal substrate receiving portion 18 as shown in FIG. 1 or in the distal substrate receiving portion 20 as shown in FIG. 2. The aerosol-generating article 22 comprises solid aerosol-forming substrate 24. Additionally, an article susceptor 56 is provided embedded into the solid aerosol-forming substrate 24 of the aerosol-generating article 22. When subjected to the alternating magnetic field of the induction coil 32, the article susceptor 56 will generate heat thereby heating the solid aerosol-forming substrate 24. The article susceptor 56 is arranged along a longitudinal central axis of the aerosol-generating article 22. The article susceptor 56 is preferably configured to generate the required heat for optimally heating the solid aerosol-forming substrate 24 when subjected to the alternating magnetic field of the single induction coil 32. To optimize the generated heat by the article susceptor 56, the article susceptor 56 may have one or more of a different heating surface, a different length, a different width, a different thickness, a different material, and a different cross-sectional shape than a cartridge susceptor described in the following.

FIG. 6B shows the cartridge 26 in more detail. The cartridge 26 is configured to be receiving in the distal substrate receiving portion 20 as shown in FIG. 1 or in the proximal substrate receiving portion 18 as shown in FIG. 2. The cartridge 26 comprises liquid aerosol-forming substrate 28. Additionally, a cartridge susceptor 58 is provided in the liquid aerosol-forming substrate 28 of the cartridge 26. When subjected to the alternating magnetic field of the induction coil 32, the article susceptor 56 will generate heat thereby heating the liquid aerosol-forming substrate 28. The cartridge 26 comprises an internal central airflow channel which enables air to be drawn axially through the cartridge 26. The cartridge susceptor 58 is arranged along a longitudinal central axis of the cartridge 26. The cartridge susceptor 58 is preferably configured to generate the required heat for optimally heating the liquid aerosol-forming substrate 28 when subjected to the alternating magnetic field of the single induction coil 32. To optimize the generated heat by the cartridge susceptor 58, the cartridge susceptor 58 may have one or more of a different heating surface, a different length, a different width, a different thickness, a different material, and a different cross-sectional shape than the article susceptor 56 described above. By having the article susceptor 56 and the cartridge susceptor 58 being different, both the solid aerosol-forming substrate 24 and the liquid aerosol-forming substrate 28 is preferably optimally heated using a single induction coil 32. The single induction coil 32 heats the article susceptor 56 and the cartridge susceptor 58 at the same time.

FIG. 7 shows two options of using the aerosol-generating device 10. In FIG. 7A, no cartridge 26 is received in the distal substrate receiving portion 20. Hence, only an aerosol-generating article 22 is received in the proximal substrate receiving portion 18 or in both the proximal and distal substrate receiving portion 20. During use, only the solid aerosol-forming substrate 24 of the aerosol-generating article 22 will be heated by means of the induction coil 32 and the article susceptor 56.

In FIG. 7B, a cartridge 26 is received in the distal substrate receiving portion 20. Additionally, an aerosol-generating article 22 is received in the proximal substrate receiving portion 18. During use, the solid aerosol-forming substrate 24 of the aerosol-generating article 22 will be heated by means of the induction coil 32 and the article susceptor 56. Additionally, the liquid aerosol-forming substrate 28 of the cartridge 26 will be heated by means of the induction coil 32 and the cartridge susceptor 58. Due to the aerosol-generating article 22 abutting the cartridge 26, the aerosol-generating article 22 will stick out further from the proximal opening of the cartridge 26 of the top portion 12.

FIG. 8 shows an alternative to the axial sliding configuration of the first housing portion 44 and the second housing portion 46 of the top portion 12 as described with reference to FIG. 3 to 5. Instead, a door 60 is provided adjacent the distal substrate receiving portion 20. The door 60 is hingely attached at a sidewall of the top portion 12. The door 60 can be opened to enable lateral access to the distal substrate receiving portion 20 to enable insertion and removal of cartridge 26 into/from the distal substrate receiving portion 20.

The induction coil 32 may be partly housed in the door 60. Electrical contacts of the induction coil 32 may be connected with the power supply of the main body 14 when the door 60 is closed. The door 60 may thus have a double functionality, namely to enable access to the distal substrate receiving portion 20 and to enable/disable operation of the induction coil 32 by closing/opening of the door 60. The induction coil 32 in the door 60 may be operable if the door 60 is closed. Alternatively or additionally, a sensor may be provided to detect the presence of a cartridge 26 in the distal substrate receiving portion 20. The controller may be configured to enable operation of the induction coil 32, if the sensor detects the presence of a cartridge 26 in the distal substrate receiving portion 20.

1-17. (canceled)

18. An aerosol-generating system, comprising:
a first aerosol-generating article comprising a first aerosol-forming substrate;
a second aerosol-generating article comprising a second aerosol-forming substrate, wherein the first aerosol-forming substrate is different from the second aerosol-forming substrate; and
a hybrid aerosol-generating device comprising
a main body comprising a power supply, wherein the main body is arranged at a distal end of the hybrid aerosol-generating device,
a top portion comprising a cavity, wherein the cavity comprises
a proximal substrate receiving portion configured to receive the first aerosol-generating article,
a distal substrate receiving portion configured to receive the second aerosol-generating article, and
an airflow channel extending along a longitudinal axis of the cavity,
wherein the top portion is arranged at a proximal end of the hybrid aerosol-generating device, and
an induction coil extending parallel to a longitudinal axis of the hybrid aerosol-generating device at least partly over the proximal substrate receiving portion and at least partly over the distal substrate receiving portion, wherein the proximal substrate receiving portion is configured to receive the aerosol-generating article comprising a solid aerosol-forming substrate and the distal substrate receiving portion is configured to receive a cartridge comprising a liquid aerosol-forming substrate, or wherein the proximal substrate receiving portion is configured to receive a cartridge comprising a liquid aerosol-forming substrate and the distal substrate receiving portion is configured to receive the aerosol-generating article comprising a solid aerosol-forming substrate, and wherein the proximal substrate receiving portion configured to receive the cartridge is configured to laterally receive the cartridge.

19. The aerosol-generating system according to claim 18, wherein a housing portion of the top portion is configured to be axially movable relative to the distal substrate receiving portion to enable opening and closing of the distal substrate receiving portion.

20. The aerosol-generating system according to claim 19,
wherein the top portion further comprises a locking element, and
wherein the locking element is configured to prevent detachment of the housing portion from the distal substrate receiving portion during axial movement of the housing portion relative to the distal substrate receiving portion.

21. The aerosol-generating system according to claim 19,
wherein one or both of the housing portion and the distal substrate receiving portion comprises a biasing element, and
wherein the biasing element is configured to bias the housing portion away from the distal substrate receiving portion.

22. The aerosol-generating system according to claim 21,
wherein one or both of the housing portion and the distal substrate receiving portion comprises a releasing element, and
wherein the releasing element is configured to release the biasing element upon a user interaction.

23. The aerosol-generating system according to claim 18, wherein the distal substrate receiving portion comprises a door configured to enable lateral insertion of the cartridge.

24. The aerosol-generating system according to claim 18, wherein the induction coil fully extends over one or both of the distal substrate receiving portion and the proximal substrate receiving portion.

25. The aerosol-generating system according to claim 18, wherein the induction coil fully extends over the cavity of the top portion.

26. The aerosol-generating system according to claim 18, wherein one or both of the main body and the distal substrate receiving portion comprises an air inlet configured to allow ambient air to be drawn into the airflow channel of the hybrid aerosol-generating device.

27. The aerosol-generating system according to claim 26, wherein the airflow channel comprises a first portion fluidly connecting the air inlet with the distal substrate receiving portion.

28. The aerosol-generating system according to claim 26,
wherein the first portion comprises an upstream part and a downstream part, and
wherein the downstream part extends along a longitudinal central axis of the cavity.

29. The aerosol-generating system according to claim 26, wherein the air inlet is arranged at a proximal end of the top portion and fluidly connects the air inlet and the distal substrate receiving portion by a 180-degree turn in the airflow channel.

30. The aerosol-generating system according to claim 26, wherein the distal substrate receiving portion comprises a second portion of the airflow channel fluidly connecting the distal substrate receiving portion with the proximal substrate receiving portion.

31. The aerosol-generating system according to claim 30, wherein the second portion of the airflow channel fluidly connects the distal substrate receiving portion with the proximal substrate receiving portion via a separator element.

32. The aerosol-generating system according to claim 31, wherein the second portion of the airflow channel extends along the longitudinal axis of the cavity.

33. The aerosol-generating system according to claim 26, wherein the top portion further comprises a third portion of the airflow channel fluidly connecting the proximal substrate receiving portion with a proximal opening of the cavity of the top portion.

34. The aerosol-generating system according to claim 33, wherein the third portion of the airflow channel extends along the longitudinal axis of the cavity.

35. The aerosol-generating system according to claim 18, wherein the airflow channel extends along a central longitudinal axis through one or both of the first aerosol-generating article and the second aerosol-generating article.

36. The aerosol-generating system according to claim 18, wherein one or both of:
the first aerosol-generating article comprises a solid aerosol-forming substrate and a heating element, wherein the heating element comprises a susceptor material, and
the second aerosol-generating article comprises a liquid aerosol-forming substrate and a heating element, wherein the heating element comprises a susceptor material.
